(19) United States
(12) Patent Application Publication
(10) Pub. No.: US 2024/0135142 A1
(43) Pub. Date: Apr. 25, 2024

(54) COMPUTING SERVICES ARCHITECT

(71) Applicant: Dell Products, L.P., Round Rock, TX (US)

(72) Inventors: Nisanth Mathilakath Padinharepatt, Palakkad District (IN); Pratika Dola, Bangalore (IN); Shital Tank, Rajkot (IN); Ashish Gupta, Bangalore (IN); Shruti Zalpuri, Jammu (IN)

(21) Appl. No.: 17/969,676

(22) Filed: Oct. 18, 2022

(51) Int. Cl. G06N 3/04; G06N 3/08

(52) U.S. Cl. CPC G06N 3/0445; G06N 3/08

(57) ABSTRACT

A computing system module facilitates designing a cloud computing services application that comprises multiple disparate cloud computing services available from multiple sources, vendors, or platforms. A description, in textual or verbal form, of desired functionality of the application is converted into a context vector. A trained supervised learning model having a number of nodes corresponding to a number of available computing services, analyzes the context vector and determines a relative probability for each node with respect to probability thresholds. The learning model identifies in a recommendation report that the application should include a service if a probability corresponding to the service satisfies a respective criterion. Edges may be determined from the context vector and analyzed by the learning model to determine an architecture of recommended services. The architecture may be rendered as a visual diagram based on the edges. Information from actual use may update training of the learning model.

### BACKGROUND

The term ‘cloud’ may refer to a set, group, collection, or other plurality of computing resources, components, services, instances, collections, application, and the like that may be accessed by a computing resource, typically via a communication network (a communication network may also be referred to as a cloud). The term ‘cloud’ may be used in referring to computing resources without referencing specific items them make up the cloud resources when discussing computing functionality from the perspective of a computing resource that may make use of the computing functionality.

A cloud computing service provider may make available various computing resources, for example, software as a service, virtual machines, processing, databases, storage, bare metal computing hardware, or even a complete enterprise's infrastructure and development platforms, over a communication network. A cloud services provider may make a public cloud computing resource available to users over a publicly accessible network, such as the Internet. A private cloud computing resource is typically available or accessible only by a given customer, such as an enterprise and its employees. Computing resources may be provided from an enterprise's own on-premises data center or from a data center operated by an independent (e.g., independent from the enterprise customer) cloud services provider. A hybrid cloud may connect an organization's private cloud services and resources of public clouds into an infrastructure that facilitates the organization's applications and workloads in a manner that balances the maximizing of performance and the minimizing of costs across public and private cloud computing resources.

Cloud providers, whether providers of public or private computing resources, may use clustering of servers. A server cluster typically comprises servers that share a single Internet Protocol (“IP”) address. Clustering enhances data protection typically, availability, load balancing, and scalability. A server associated with a cluster may be referred to as a node, which may comprise a hard drive, random access memory, (“RAM”), and central processing unit (“CPU”) resources.

In a cloud services platform/marketplace, like that of APEX™ cloud services offered by Dell Inc., there may be hundreds of computing service resources, modules, functions, or functionality that may be offered that a designer may select from to create a custom computing service functionality application. To create a custom cloud computing services application from scratch, a user/designer beginning development of a cloud solution may be overwhelmed with a large number and variety of available services from one or more cloud computing services providers. Moreover, unless the designer is an experienced cloud services architect, or designer, with knowledge of available services or functionalities available from specific cloud service providers, designing an initial computing services application architecture, or solution, to a given problem, by selecting the best services from a large number of available services would likely be a daunting, or at least time-consuming undertaking.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method, may comprise receiving, by a system comprising a processor and via a user interface, a description of at least one computing service functionality, wherein the description comprises at least one description item. A description item may be a word, a term, an image, a sound, or other type of information. The method may comprise applying, by the system, an embedding function to the description to result in an embedded description, wherein the embedded description comprises at least one description item vector corresponding to the at least one description item. A description item vector may be referred to as an embedded vector or an embedding vector.

The example method may comprise inputting, by the system, or to the system, the at least one description item vector to a neural network, or a neural network function, which may comprise multiple layers of recurrent neural network functionality, such as, for example, long short-term memory functionality, or gated recurrent unit functionality, to result in a context vector. A context vector may be referred to as a super vector (e.g., it is derived from multiple description item vectors). The example method may comprise analyzing, by the system, the context vector using a trained supervised learning model to result in an analyzed context vector, wherein the trained supervised learning model is trained using a training corpus that associates at least one training functionality description with a corresponding at least one training computing service; and outputting, via the user interface, based on the analyzed context vector, a computing service recommendation of at least one recommended computing service to perform the at least one computing service functionality.

The at least one description item may comprise comprises at least one of: at least one word, at least one image signal representing at least one portion of at least one image, or at least one audio signal representing at least one portion of at least one sound. The computing service recommendation may comprise an arrangement of recommended computing services to perform the at least one computing service functionality. The context vector may comprise at least one of: a usage frequency of the at least one description item or an order of the at least one description item.

In an embodiment, the analyzed context vector may comprise at least one computing service probability corresponding to at least one computing service to perform the at least one computing service functionality, and the method may further comprise determining, by the system, the computing service recommendation based on the at least one computing service probability being determined to satisfy at least one functionality probability criterion corresponding to the at least one training computing service. A computing service probability may be a relative probability determined by a softmax activation function that is part of the supervised learning model.

In an embodiment, the example method may further comprise determining, by the system (e.g., analyzing the context vector using the supervised learning model), edges for at least one pair of the at least one recommended computing service; and determining, by the system, the computing service recommendation based on at least one edge, of the edges, having an edge probability that is determined to satisfy an edge probability criterion corresponding to the at least one training computing service.

The trained supervised learning model may be updated using actual data or information from use of the system to result in an updated trained supervised learning model. The training functionality description and corresponding at least one training computing service may be updated, or (re)trained, with an updated corpus that includes a description of the at least one computing service functionality and the computing service recommendation based thereon that result from a user using the method running on the system to obtain a recommendation of computing services to use, and a recommendation of how to use/arrange the services, to result in an application that performs computing functionality expressed in a description input to the system by the user via the user interface.

### BRIEF DESCRIPTION OF THE DRAWINGS

FIG. 1A illustrates a cloud computing services environment.

FIG. 1B illustrates a cloud computing services environment with a computing services recommendation.

FIG. 2 illustrates an example artificial intelligence system to recommend a design of one or more computing services to achieve a described cloud computing functionality.

FIG. 3 illustrates a table of an example training corpus of computing service functionality descriptions and corresponding list of computing services.

FIG. 4 illustrates a table of an example training corpus of computing service functionality descriptions and corresponding list of computing services with graph edges.

FIG. 5 illustrates an example computing service architecture recommendation.

FIG. 6 illustrates an example computing service architecture recommendation.

FIG. 7 illustrates a flow diagram of an example method.

FIG. 8 illustrates a block diagram of an example method.

FIG. 9 illustrates a block diagram of an example system.

FIG. 10 illustrates a block diagram of an example non-transitory machine-readable medium embodiment.

FIG. 11 illustrates an example computer environment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

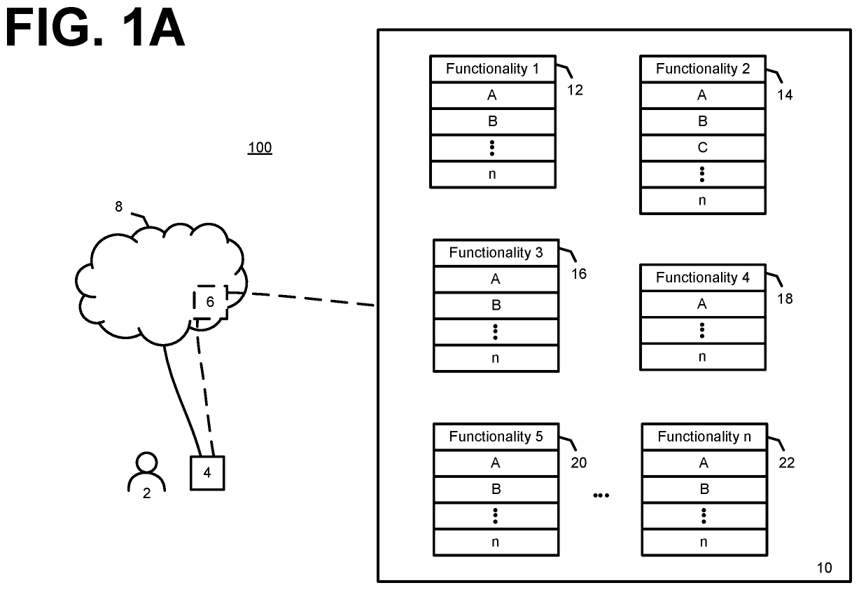

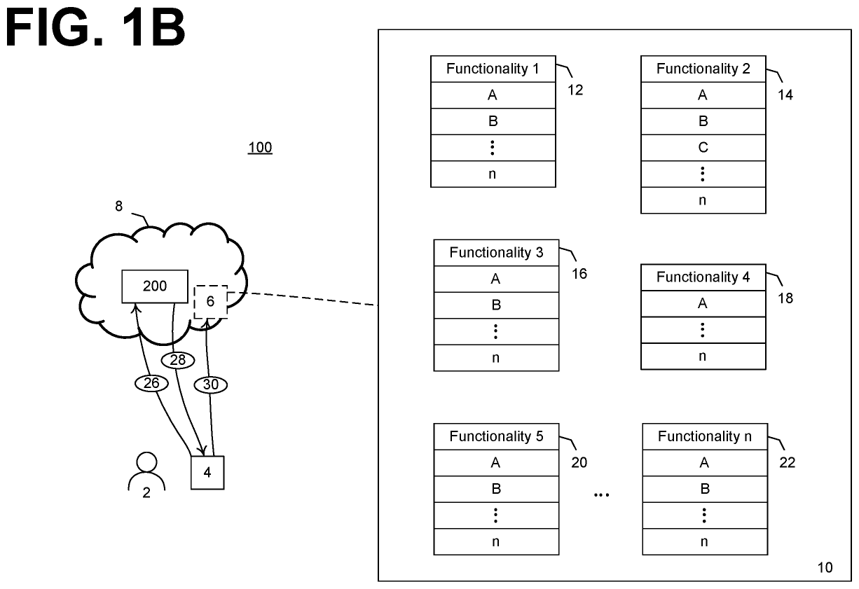

Meaningful suggestions or recommendations with respect to cloud computing services, or cloud computing services functionality, that may be available from one or more cloud computing services providers may be helpful to a designer in selecting one or more computing services, from multiple services that may be available in a cloud computing services marketplace, to help an application designer/architect, develop an application, or solution, with functionality that developer/architect may desire. Turning now to the figures, FIG. 1A illustrates an example cloud computing services environment 100. A developer/architect user 2, which may be referred to herein simply as ‘user’, such as an applications engineer, application architect, or an information technology specialist, who may be a private individual or who may be personnel working for an enterprise, may desire to design, using a user interface 4, a computing solution 6 to perform one or more computing functions that run on, are executed by, are accessible via, or are otherwise facilitated by a cloud computing system represented by cloud 8. FIG. 1A shows computing functionality application 6, and the line connecting the functionality application to user interface 4, in broken lines to indicate that the computing functionality application has not been created yet by user 2. User 2 may choose from multiple computing services 10, that are shown organized according to functionality categories, 12, 14, 16, 18, 20, and 22 in FIG. 1A, with each of the categories comprising one or more services A— n. Computing functionality category 14 is shown as comprising services 14A, 14B, 14C, 14D, . . . 14n; category 18 is shown as comprising services 18A . . . 18n; and the other computing functionality categories are shown as comprising respective services A, B, . . . 14n, to indicate that a given computing functionality category may comprise a different number of services that another computing functionality category. User 2 may design a computing services application by choosing one or more services 10 from one or more cloud services providers.

Examples of cloud computing services may comprise, for example, a distributed data store optimized for ingesting and processing streaming data in real-time. Such a service may facilitate functionality of building real-time streaming data pipelines and real-time streaming applications by using, queuing and publish-subscribe messaging models. Another cloud computing service example may comprise a scalable compute platform that may provide typical functions of a complete computer, comprising processing, storage, memory, operating system, networking, etc. Yet another example of cloud computing services may comprise a serverless, event-driven computing service can run computer software code for an application or backend service without provisioning or managing of servers by an enterprise customer. Another cloud computing service may comprise database functionality.

Turning now to FIG. 1B, the figure illustrates user 2 providing a description 26 of at least one computing service functionality, wherein the description comprises at least one description item. A description item of description 26 may be in the form of text, wherein the text comprises words, for example typed into a chat bot or a dialog box, in natural language or just using key words, for example. A description item of description 26 may be in the form of verbal description (e.g., audio recording of a description dictated by user 2. A description item of description 26 may be in the form of an image, that may contain words, a diagram of computing functionality, symbols representing computing functionality, a schematic of computing functionality, and the like. Description 26 may be transmitted via the Internet, which may comprise, or to which may be coupled, cloud 8, or cloud computing services 8, to computing-services-recommending module 200.

Module 200 may interpret description 26 and, based on an interpretation resulting therefrom, and provide a recommendation 28 of recommended cloud computing services, or resources, that would likely satisfy functionality requirements, desired functionality, or other functionality corresponding to one or more description items of description 26.

Recommendation 28 may be in the form of a report that provides a listing of services that user 2 should consider in designing application 6. Recommendation 28 may be in the form of a diagram that not only recommends one or more computing services from services 10, but may also graphically show interconnections (e.g., data or information flow via inputs and outputs) of recommended services. User 2 may design manually, or may use an application design tool, to design application 6 and may provide an application design 30 that may contain computing code, information, data, and the like, to facilitate application 6 in providing services and functionality requested in description 26. Module 200 is shown as part of cloud services 200, but may be a module that runs, executes, or operates at a computing system, such as a laptop, desktop, tablet, smartphone, smartwatch, or server, that is local to user 2 relative to a location, geographical or logically, of cloud services 6.

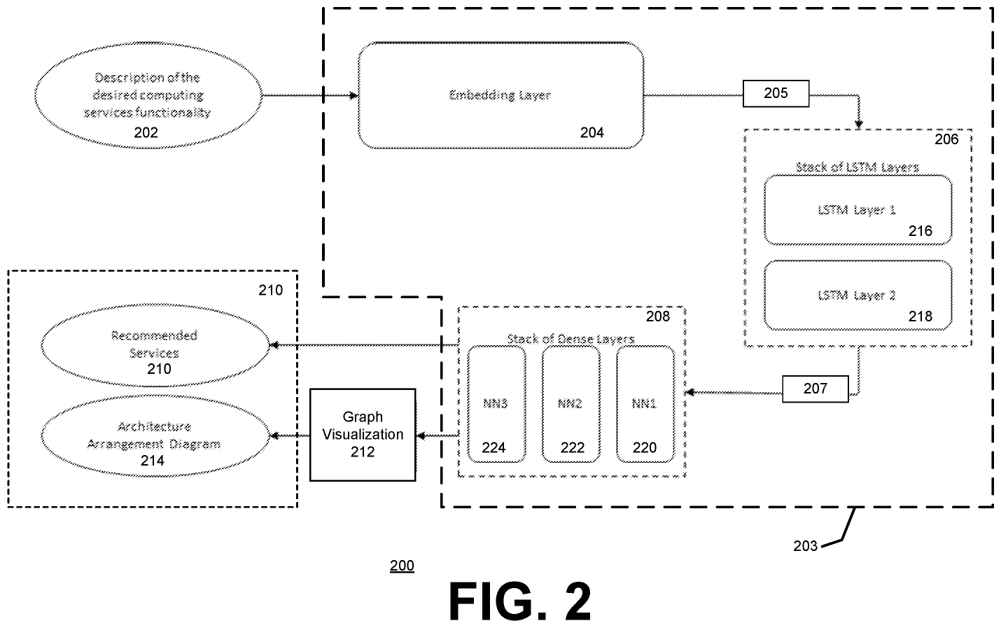

Turning now to FIG. 2, the figure illustrates an example artificial intelligence system 200 to recommend a design of one or more computing services to achieve a described functionality. System 200, referred to in the description of FIG. 1B above as a computing-services-recommending module, may comprise components, elements, modules, software, functions, or other parts shown in FIG. 2. Description interpreting component 202 may receive description 26 as shown in FIG. 1B and determined description items contained in the description. For example, if the description comprises text that a user inputs into a text box or chat box, for example, interpreting component, or interpreter, 202 may convert the text into a format that is understandable by embedding layer 204 of learning model 203, which may comprise a supervised learning model. If, for example, description 26 comprises verbal input, interpreter 202 may perform voice to text, or voice to another format, such that information contained in the description can be used by embedding layer 204. Learning model 203 may comprise other components, elements, modules, processes, etc., as described below. Learning model 203 and components thereof, may be trained separately or individually, using a corpus of previously collected information and data related to computing services. Embedding layer 204 and long short-term memory (“LSTM”) 206 stack may be pretrained using a generic corpus before training that uses the corpus of collected information or data related to computing services. In an embodiment, instead of, or in addition to, LSTM 206 stack, a gated recurrent unit (“GRU”) could be used. LSTM and GRU are examples of recurrent neural networks (“RNN”), which may have a capability to be trained using a sequence of entities and to determine interrelations between entities and the context of a sequence. It will be appreciated that other types of RNNs could be used instead of LSTM or GRU stacks, or layers. Embedding layer 204 may comprise, a function that receives raw inputs (e.g., in the case of word embeddings, the raw inputs might be unique integers, or indices, corresponding to words as determined by interpreter 202 with a different integer corresponding to each word). Embedding layer 204 may transform the integers, indices, into a sequence of embeddings 205, or embedding vectors, having a determined number of dimensions, with each embedding vector having different values, or factors, such as latent factors, for each dimension, for different indices. Thus, a given term of description 26 may correspond to a unique embedding vector, which may be referred to herein as a description item vector, that comprises a shorter value (e.g., fewer bits) than if a one-hot or cold-hot vector were used to represent each word of a dictionary that could comprise thousands of terms. As an example, a one-hot vector for a dictionary having 2,000 words, may use, for example, 2,000 bits, or dimensions, with a bit assigned to a given word being ‘1’ for that particular word with all other bits being ‘0’, whereas an embedded vector could comprise fewer dimensions, for example thirty, with each dimension comprising a weighting factor, and wherein the embedding vectors may be stored to a embedding matrix. At the expense of a slight decrease in accuracy, using an embedding vector to represent a term of description 26 may require less computational resources to process a description 26 than using a one-hot vector (or a one-cold vector where all bits are a ‘1’ except for the bit corresponding to a given word being a ‘0’).

The sequence of description item vectors 205 is input to LSTM stack, or module 206, which may comprise one or more LSTM layers 216 and 218. LSTM module 206 may produce as an output a long description-vector, or descriptor, 207, which may combine individual outputs corresponding to a description item vector of the input sequence of description item vectors. Vector 207 that is output from LSTM module 206 may be referred to as a super vector. Vector 207 may also be referred to as a context vector that provides more information than just use of certain words in a description 26. LSTM module 206 may determine context vector 207 based on a number of occurrences of a particular word, or words, in description 26. Context vector 207 may also be determined based on placement of certain words relative to the placement of other words, in description 26. Thus, a context of description 26 may be determined, or inferred, based on words used in description 26 and how those words are used. For example, depending on the order of key words (e.g., words in description 26 that are not common words like prepositions, articles, variations of ‘to be’, etc.) as well as the relationship of common words to key words, a relationship of the words of description of 26 (e.g., context) may be determined, and from the context of the description, edges may be determined as discussed below. (Use of the term edge herein refers to a representation of a connection between vertices as used in graph theory wherein the edges do not necessarily define a specific geometrical shape, or layout, unlike the use of line segments that may be used to define, or to show, polygon or polyhedron geometric shapes, for example.) Context vector 207, which may comprise a mathematical representation of description 26, is fed to dense layer stack 208, which may comprise multiple connected neural network layers 220, 222, and 224. Dense layer stack 208 may comprise, or may be referred to, as a trained supervised learning model.

As shown in FIG. 2, neural network may comprise activation functionality, for example at layer 224. The activation functionality may comprise a softmax activation function. A softmax function may be continuous and differentiable whereas a function, such as for example, an argmax function, may output a one-hot vector, and may not be continuous or differentiable. A softmax activation function may provide an output prediction based on a probability distribution.

Thus, dense stack module 208 may output relative probabilities for each of the available cloud services 10 shown in FIGS. 1A and 1B to be used to determine cloud computing services 210 that recommendation 28 should comprise, or dense shack module 208 may output relative probabilities for each of multiple possible edges that may connect recommended cloud computing services of recommendation 28. Edges may be used to determine an architectural diagram 214, or graph, showing a recommended arrangement of interconnections, or relationships, of inputs and outputs of the recommended cloud computing services based on description 26. Embedding module 204, LSTM module 206, or dense layer module 208, or learning models thereof, may be trained based on one or more descriptions 26 and respective recommendations 28 corresponding thereto.

One or more relative probabilities determined by softmax activation functionality 224 of dense layer module 208 that correspond to computing services 10 may be analyzed with respect to a computing service functionality probability criterion, or to computing service functionality probability criteria, such as one or more thresholds. The one or more thresholds, or other functionality probability criteria may be empirically determined by, for example, manually adjusting threshold values, or other criteria values, and performing one or more iterations of providing a description of desired computing services that are associated with a known desirable listing or cloud computing services, or a desirable arrangement or computing services, until a recommendation 28 recommends the known desirable listing or arrangement of computing services corresponding to the input description of desired computing services functionality.

Graphing visualization module 212 may receive an output from neural network layer module 208 and use relative edge probability determinations corresponding thereto to generate one or more visual depictions of one or more architectural arrangements 214 of services that may be included in listed recommended services 210.

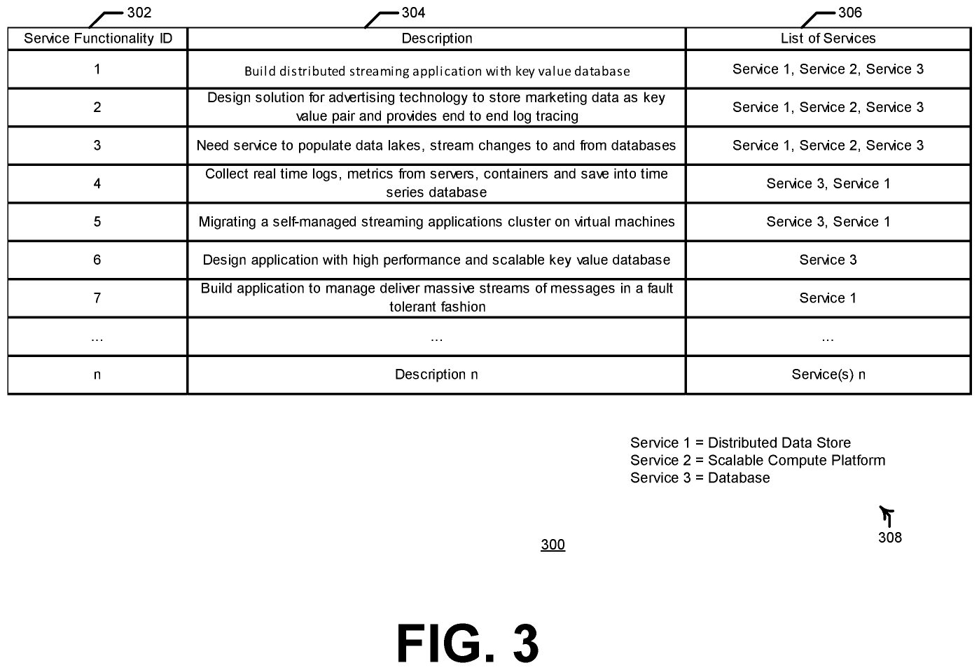

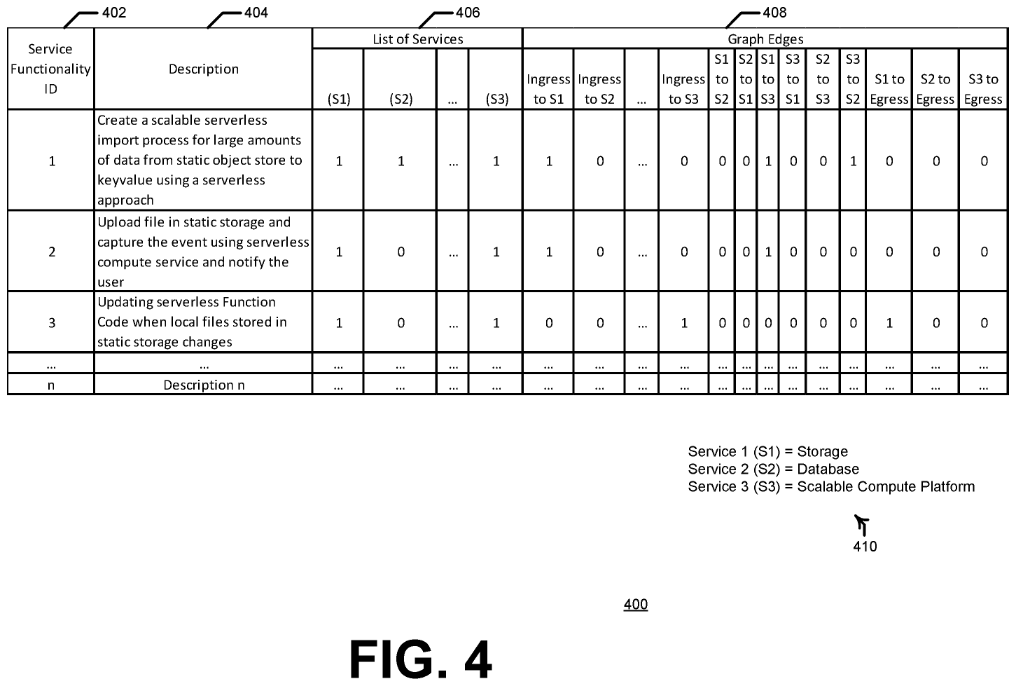

Artificially intelligent cloud services solution architect module 200 can take a verbal description of the problem a user wants to solve, or computing functionality that the user wishes to implement as input(s) and output a suggestion/recommendation of a list of relevant services and a possible architecture arrangement in a diagram/graph to the user. An initial dataset may be used to train two neural net models—one for recommending a list of relevant services, and another one for recommending a possible architecture diagram/graph connecting these services. Different datasets may be used to train for only recommending services or for recommending services and an arrangement thereof. Example of a training dataset, including sample inputs to the trained models and corresponding outputs are shown in FIG. 3 and in FIG. 4 and are described in reference thereto below.

Turning now to FIG. 3, the figure illustrates a table of an example training corpus 300 of computing service functionality descriptions 304 and corresponding list of known desired computing services 306. Each description 304 may correspond to information input by a user 2 as show in in FIG. 1, via interface 4 as a description 26. Services 306 corresponding to respective descriptions 304 may comprise one or more services 10 shown in FIG. 1. The description column contains a problem description, or a description of desired functionality, and the list of respective corresponding services may be labels used in training.

Respective service functionality identifiers 302 may correspond to descriptions 304 and may be values assigned by interpreter 202 shown in FIG. 2. Legend 308 maps example services 1, 2, and 3 to respective cloud computing services functionality, one or more of which may be shown as listed services 306.

Module 200 can recommend a list of services based on functionality contained in the input description. For example, for an input desired functionality description of: “Build scalable application to ingest email metadata into a data stream and record in key value store” module 200 may produce a recommendation 28 that lists recommends services as Output: Service (1), Service (2), and Service (3).

Turning now to FIG. 4, the figure illustrates a table of an example training corpus 400 of computing service functionality descriptions 404 and corresponding list of computing services 406 and corresponding graph edges 408. Descriptions 404 may be created to represent likely natural language that may be similar to language used in a request 26. Services 406 and edges 408 corresponding to a respective description 404 may be known services or edges, or services or edges that have been determined to be desirable cloud computing services that have been determined to satisfactorily implement an application that performs functionality described in the respect description 404. Legend 408 provides a mapping of three types of cloud computing services to abbreviations used in headings of the table shown in FIG. 4. As described above, service functionality identifier 402 may be used by stages 202 or 204 of module 200 as described above in reference to FIG. 2.

Continuing with description of training corpus 400 shown in FIG. 4, more detail is shown than in FIG. 3 regarding the recommended services 406 (and recommended edges 408) with respect to a given description. As shown in FIG. 4, 1s and 0s for a given description 404 may correspond to a context vector 207 as described above in reference to FIG. 2. Multiple training context vectors that may be applied during training of neural network dense layer 208, may be used to train neural network layers 220, 222, or 224 to determine functionality probability criterion, or criteria, such as one or more thresholds as described above. It will be appreciated that corpus 400 shown in FIG. 4 is described as a training corpus. However, if a description similar to description 404 corresponding to service functionality identifier 402 #2, for example, were input two stage 202 shown in FIG. 2 as a context vector 207 that comprises is and 0s as shown in FIG. 4 corresponding to identifier 402 #2 would be provided to neural network layer 208, which should output a recommendation 210 of services S1 and S2 and may also output a recommendation 214 of an arrangement of services S1 and S2 with a connection between S1 and S2 corresponding to the 1 shown in the table of FIG. 4 corresponding to service functionality identifier 402 #2.

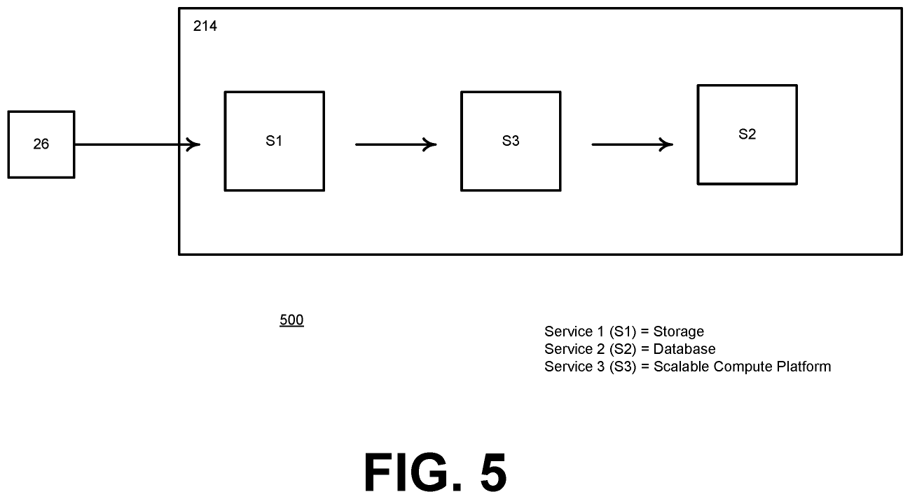

Turning now to FIG. 5, the figure illustrates an example computing service architecture recommendation 500 that may be provided as an architecture recommendation diagram 500 that corresponds to recommendation 214 as shown in FIG. 2 of a recommendation 28 described in reference to FIG. 1B. Module 200 can recommend a list of cloud computing services and a recommended architecture diagram corresponding to the recommended services for the input desired computing functionality. Module 200 may generate and output diagram 500 in response to a verbal or textual input description of “Create a scalable serverless import process for large amounts of data from static object store to key value database.” This may be generated after module 200 has been trained using corpus 400. As shown in FIG. 4, description 404 corresponding to functionality identifier 402 #1 contains text that is very similar to the textual input description in the example. The list of services 406 corresponding to functionality item 402 #1 in corpus 400 includes a “1” for Service 1, a “1” for Service 2), and a “1” for Service 3. Also shown in FIG. 4, graph edges in corpus 400 shows a “1” for ingress to Service 1, a “1” indicating an edge from S1 to S3. Thus, diagram 500 shows ingress to service 1, and output from Service 1 flowing to Service 3. No egress is shown from Service 3 because there is a“0” instead of a “1” in the cell corresponding to the “S3 to Egress” column and functionality identifier #1 in corpus 400.

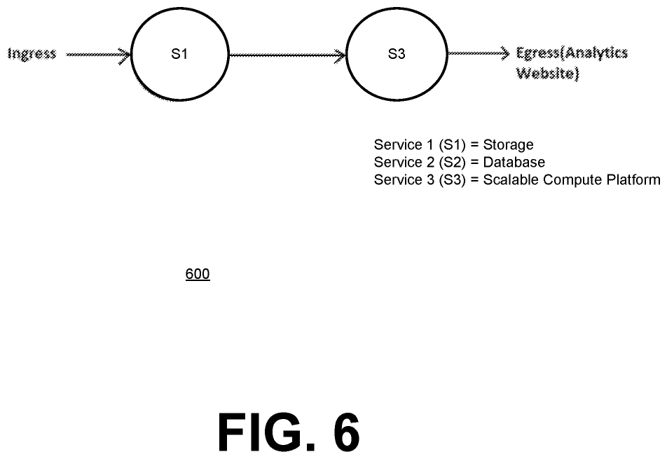

Turning now to FIG. 6, the figure illustrates another example computing service architecture recommendation diagram 600 that corresponds to recommendation 214 as shown in FIG. 2 of a recommendation 28 described in reference to FIG. 1B. In response to a user's input: “Set up serverless ingest pipeline from the static object store bucket into our analytics website” Module 200 recommends architecture diagram 600. Module 200 recommends Storage (Service 1) and Scalable Compute Platform (Service 3), with ingress to Service 1 and egress from Service 3. Thus diagram 600 corresponds to the appearances of “1s” and “0s” for functionality identifier #2 of corpus 400 shown in FIG. 4 insofar as functionality identifier #2 appears to be the most similar to the description that was input by the user.

After module 200 has been initially trained, the module may be deployed as stand-alone services, instance, module, application, or other computing component, or as part of a system, such as, for example, a cloud-platform marketplace. Descriptions input to module 200, and actual applications/solutions that are created based on, and corresponding to, those descriptions, may be used to update the training of module 200 as more and more users use the module. Such updated data, which may be labelled data, may be used to train portions of module 200, including neural network module layers 216 and 218, improve quality of recommendations of services and arrangements thereof. As the neural network layers 208, or other trainable components of module 200, such as LSTM layers 216 or 218, or embedding layer module 204, are used to recommend services in response to descriptions input by users, the trainable components may be updated, or retrained, with one or more revised, or updated, corpuses, that may be updated based on services recommended by module 200 in response to descriptions, or updated corpuses may be updated based on services actually selected by users to implement solutions that address functionality expressed in descriptions from the users. Users may input a verbal description of a problem, or functionality needed, or desired. Module 200 may provide suggestions of relevant services to look at to implement a cloud computing solution to address the desired functionality. A services suggestion list may be determined by feeding in tokenized descriptions of desired functionality described in a description from a user and may be used to train a supervised learning model, such as neural network model 208. Neural network model 208 may determine output probabilities of multiple services that may be available for use by a user and the neural network model may analyze the probabilities with respect to determined, or predetermined, criteria, such as thresholds, corresponding to the available services. Based on a probability satisfying a criterion, for example a probability corresponding to a service exceeding a threshold that is associated in the neural network model with the service, module 200 may output a recommendation that recommends the cloud computing service, or services, for which the probability satisfies a criterion associated therewith.

In addition to recommending cloud computing services, module 200 may also output an architecture of an arrangement of the services. Neural network model 208 may determine edges corresponding to the recommended services. The edges may be used to determine an architectural diagram/graph, by determining output probabilities of the edges, analyzing the edge probabilities with respect to edge probability criteria, and selecting those edges that satisfy the edge probability criteria, which may comprise determined, or predetermined, probability criteria, and which may comprise edge probability thresholds. thresholds, and further filtering to include only those edges. The selected, or recommended, list of services and corresponding edges between them may be used to generate architectural diagram/graph data, or information. A visualization of the architectural diagram data for display, or rending, on a graphical user interface, such as interface 4, may be generated, using a visualization tool, such as, for example, Graphviz (open-source graph visualization software) or similar, which may process the list of nodes (e.g., recommended services) and corresponding edges and output a visual representation of the diagram data. It will be appreciated that Graphviz is only an example of an application that may be used for converting a list of edges into a graphical display to be presented to the user requesting an architectural arrangement of recommended computing services and that other applications may be used instead of Graphviz.

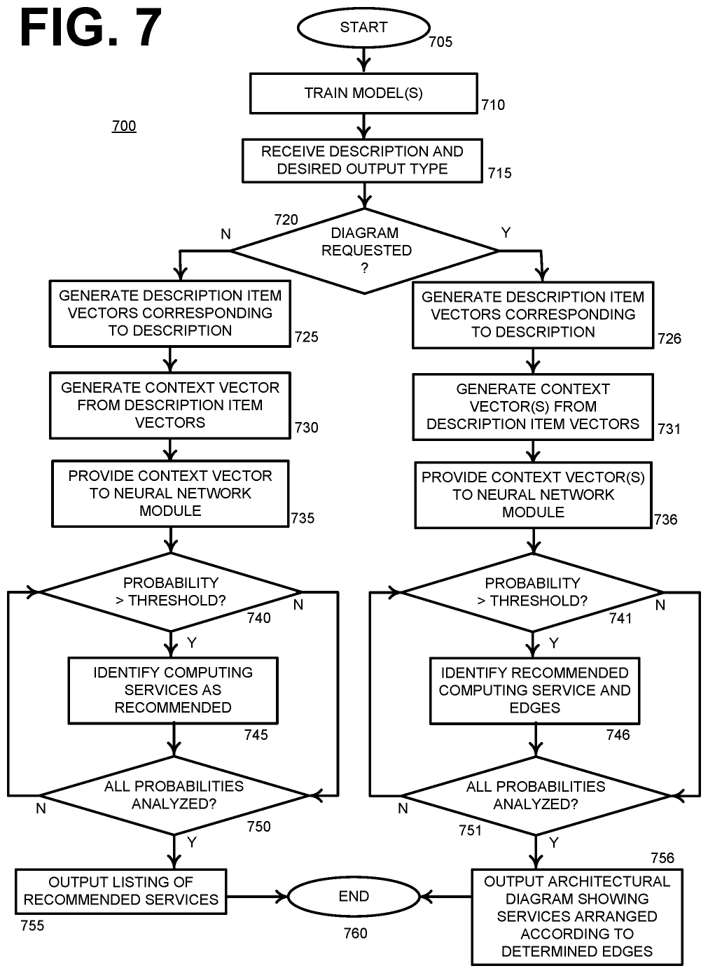

Turning now to FIG. 7, the figure illustrates a flow diagram of an example method embodiment 700. Method 700 begins at act 705. At act 710 a computing-services-recommending module may comprise a learning model that is trained to result in a trained computing-services-recommending module learning model using a corpus of descriptions of cloud computing service functionality and computing services that have been determined to provide the described functionality. A corpus may include edge data that corresponds to graph of edges that connect computing services, wherein one or more edges and one or more corresponding services that the edges connect are associated with a description of cloud computing service functionality.

A first training corpus that does not comprises edge data may be used to train a first learning model that may be used to output recommended computing services. A second training corpus that comprises edge data may be used to train a second learning model that may be trained to output an architecture, or arrangement, of recommended computing services. Although the first learning model and the second learning model may contain similar components arranged in similar fashion as described above in reference to learning model 203 shown in FIG. 2, different RNN layers, or a different number of RNN layers, may be used, and different dense layers, or a different number of dense layers, may be used to recommend a listing of computing services than layers or numbers of layers that may be used to recommend an architectural arrangement of computing services. Furthermore, a number of output nodes at an activation function layer, which may comprise a softmax function, may comprise a number of available services in a learning model that is designed to output a listing of recommended computing services, whereas a number of nodes at a softmax activation function layer may comprise a number of possible edges between the available services in a learning model that is designed to be used to recommend an architectural arrangement of computing services.

At act 715 the computing-services-recommending module receives a description and a selected type of output. Examples of selected output types comprise a listing of cloud computing services that together may be used to create an application that performs the described functionality received at act 715, or an architecture/arrangement (that may include a listing of services or that may output recommended services in a certain arrangement) of listed cloud computing services that indicates a recommended arrangement of how the listed services should be ‘connected’ (e.g., how the services should be arranged to process information or data in an order that facilitates the functionality described in the description received at act 715. It will be appreciated that a first training corpus may be used to train a learning model to be used to output a listing of recommended services and that a different second corpus may be used to train a learning model to be used to output an architectural arrangement of recommended computing services. Thus, a first learning model or a first trained corpus may be used to determine a list of recommended service and a second learning model, which may be different than the first trained learning model, or a second trained corpus, which may be different than the first trained corpus, may be used to determine a recommended arrangement of recommended computing services. A corpus used to train a learning model recommend computing services may comprise pairing of described problems and corresponding respective one or more services that have been deemed to satisfactorily address the corresponding problems. A corpus used to train a learning model to recommend an architectural arrangement of computing services may comprise pairs of described problems and corresponding respective one or more edges between services that have been deemed to satisfactorily address the corresponding problems.

At act 720 a determination is made whether a request for an architectural graph that visually depicts connections between recommended cloud computing services was received at act 720. If a request for a graphical representation was not received at act 715, method 700 advances to act 725

At act 725 the computing-services-recommending module generates description item vectors that correspond to the description of functionality received at act 715. The description item vectors may correspond to words, terms, images, sounds, or other types of information included in the description of functionality received act 715. At act 730 the computing-services-recommending module generates a context vector based on the description item vectors. At act 735 the context vector is provided to a supervised learning model to recommend computing services, which supervised learning model may comprise a first learning model or a first trained corpus as described above in reference to training at act 715. The supervised learning model may comprise one or more neural network layers, one of which may comprise an activation function, such as, for example, a softmax activation function.

At act 740 the computing-services-recommending module determines whether a relative probability that is output from a neural network layer of the first supervised learning model (e.g., dense layer module 208 shown in FIG. 2) satisfies a functionality probability criterion corresponding to a computing service, which may be a training computing service (e.g., a service of a corpus that is used to train the learning model), or an updated trained computing service, that may correspond to an available computing service such as a computing service of computing services 10 described in reference to FIGS. 1A and 1B above. If a determination is made at act 740 that a relative probably corresponding to a computing service satisfies a functionality probability criterion, such as an empirically determined, or arbitrarily determined, probably threshold (e.g., 0.5), the computing-services-recommending module identifies at act 745 the computing service corresponding to the relative probability that satisfies the criterion as a cloud computing service to recommend as a service to be used to achieve functionality described in the description received at act 715. After performing act 745, or ff a determination made at act 740 is that a relative probably corresponding to a computing service does not satisfy a functionality probability criterion, method 700 advances to act 750.

At act 750, a determination is made weather all relative probabilities have been analyzed with respect to corresponding functionality probability criteria. If a determination made at act 750 is that all relative probabilities have not been analyzed method 700 returns to act 740. If a determination is made at act 750 that all relative probabilities have been analyzed with respect to corresponding functionality probability criteria method 700 advances to act 755. At act 755 a list of recommended services is generated based on a determination made at act 740 or act 745, and the list may be provided to a user to be used to implement computing functionality that was described in the description received at act 715. Method 700 advances to act 760 and ends.

Returning to description of act 720, if a determination is made at act 720 that a request was received at act 715 to provide a graphical depiction of an architecture, or an arrangement, of recommended services, method 700 advances to act 726.

At act 726 the computing-services-recommending module generates description item vectors that correspond to the description of functionality received at act 715. The description item vectors may correspond to words, terms, images, sounds, or other types of information included in the description of functionality received it at to 715. At act 731 the computing-services-recommending module generates a context vector based on the description item vectors. At act 736 the context vector is provided to a supervised learning model to recommend an arrangement of computing services, which supervised learning model may comprise a second learning model or a second trained corpus as described above in reference to training at act 715. The second supervised learning model may comprise one or more neural network layers, one of which may comprise an activation function, such as, for example, a softmax activation function.

At act 741 the computing-services-recommending module determines whether a relative probability that is output from a neural network layer of the second supervised learning model (e.g., from dense layer module 208) satisfies a functionality probability criterion corresponding to a computing service edge, which may be a training computing service edge corresponding to two or more computing services (e.g., services of a second corpus that is used to train the second learning model), or an updated trained computing service edge, that may correspond to an available computing service edge that may correspond to computing services of computing services 10 described in reference to FIGS. 1A and 1B above. If a determination is made at act 741 that a relative probably corresponding to a computing service edge satisfies a functionality probability criterion, such as an empirically determined, or arbitrarily determined, probably threshold (e.g., 0.5), the computing-services-recommending module identifies at act 746 a computing service edge that corresponds to the relative probability that satisfies the criterion as a cloud computing service edge to recommend in an arrangement of computing services to be used to achieve functionality described in the description received at act 715. After act 746 is performed, or if a determination made at act 741 is that a relative probably corresponding to a computing service does not satisfy a functionality probability criterion, method 700 advances to act 751.

At act 751, a determination is made weather all relative probabilities have been analyzed with respect to corresponding functionality probability criteria. If a determination made at act 751 is that all relative probabilities have not been analyzed method 700 returns to act 741. If a determination is made at act 751 that all relative probabilities have been analyzed with respect to corresponding functionality probability criteria method 700 advances to act 756. A graphical depiction of recommended services showing connections between the recommended services is generated at act 756, based on an edge determined at act 741 or act 746, by a graphing visualization module, which outputs an architecture arrangement diagram 214. Method 700 ends at act 760.

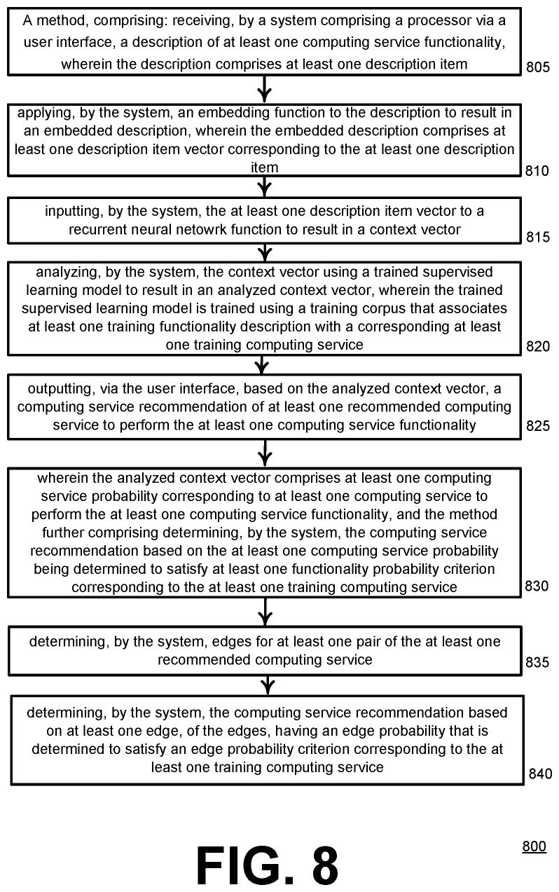

Turning now to FIG. 8, the figure illustrates an example embodiment method 800 comprising at block 805 receiving, by a system comprising a processor via a user interface, a description of at least one computing service functionality, wherein the description comprises at least one description item; at block 810 applying, by the system, an embedding function to the description to result in an embedded description, wherein the embedded description comprises at least one description item vector corresponding to the at least one description item; at block 815 inputting, by the system, the at least one description item vector to a recurrent neural network function to result in a context vector; at block 820 analyzing, by the system, the context vector using a trained supervised learning model to result in an analyzed context vector, wherein the trained supervised learning model is trained using a training corpus that associates at least one training functionality description with a corresponding at least one training computing service; at block 825 outputting, via the user interface, based on the analyzed context vector, a computing service recommendation of at least one recommended computing service to perform the at least one computing service functionality; at block 830 wherein the analyzed context vector comprises at least one computing service probability corresponding to at least one computing service to perform the at least one computing service functionality, and the method further comprising determining, by the system, the computing service recommendation based on the at least one computing service probability being determined to satisfy at least one functionality probability criterion corresponding to the at least one training computing service; at block 835 determining, by the system, edges for at least one pair of the at least one recommended computing service; and at block 840 determining, by the system, the computing service recommendation based on at least one edge, of the edges, having an edge probability that is determined to satisfy an edge probability criterion corresponding to the at least one training computing service.

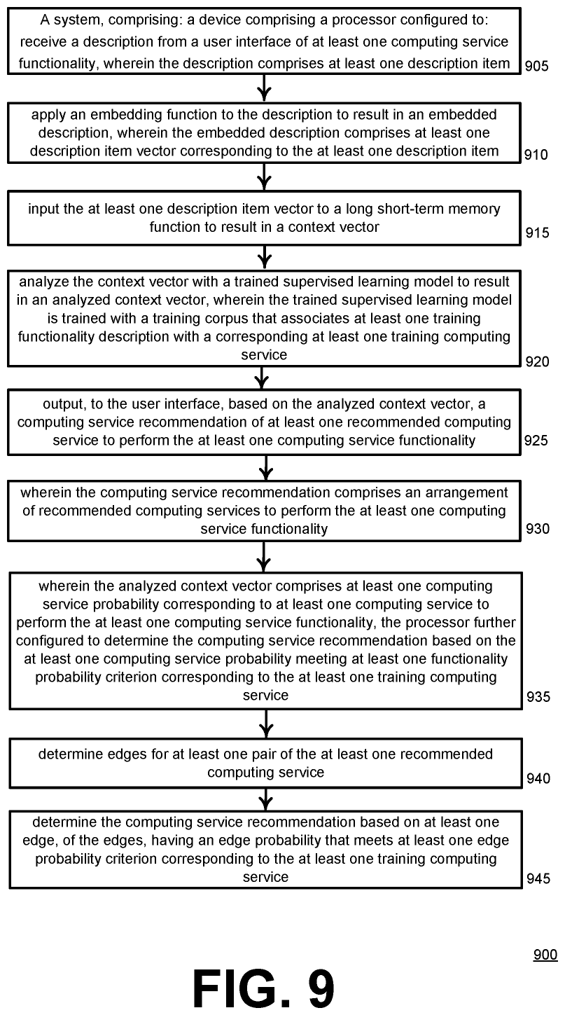

Turning now to FIG. 9, the figure illustrates an example system embodiment 900 comprising at step 905 a processor configured to receive a description from a user interface of at least one computing service functionality, wherein the description comprises at least one description item; at block 910 apply an embedding function to the description to result in an embedded description, wherein the embedded description comprises at least one description item vector corresponding to the at least one description item; at block 915 input the at least one description item vector to a long short-term memory function to result in a context vector; at block 920 analyze the context vector with a trained supervised learning model to result in an analyzed context vector, wherein the trained supervised learning model is trained with a training corpus that associates at least one training functionality description with a corresponding at least one training computing service; at block 925 output, to the user interface, based on the analyzed context vector, a computing service recommendation of at least one recommended computing service to perform the at least one computing service functionality; at block 930 wherein the computing service recommendation comprises an arrangement of recommended computing services to perform the at least one computing service functionality; at block 935 wherein the analyzed context vector comprises at least one computing service probability corresponding to at least one computing service to perform the at least one computing service functionality, the processor further configured to determine the computing service recommendation based on the at least one computing service probability meeting at least one functionality probability criterion corresponding to the at least one training computing service; at block 940 determine edges for at least one pair of the at least one recommended computing service; and at block 945 determine the computing service recommendation based on at least one edge, of the edges, having an edge probability that meets at least one edge probability criterion corresponding to the at least one training computing service.

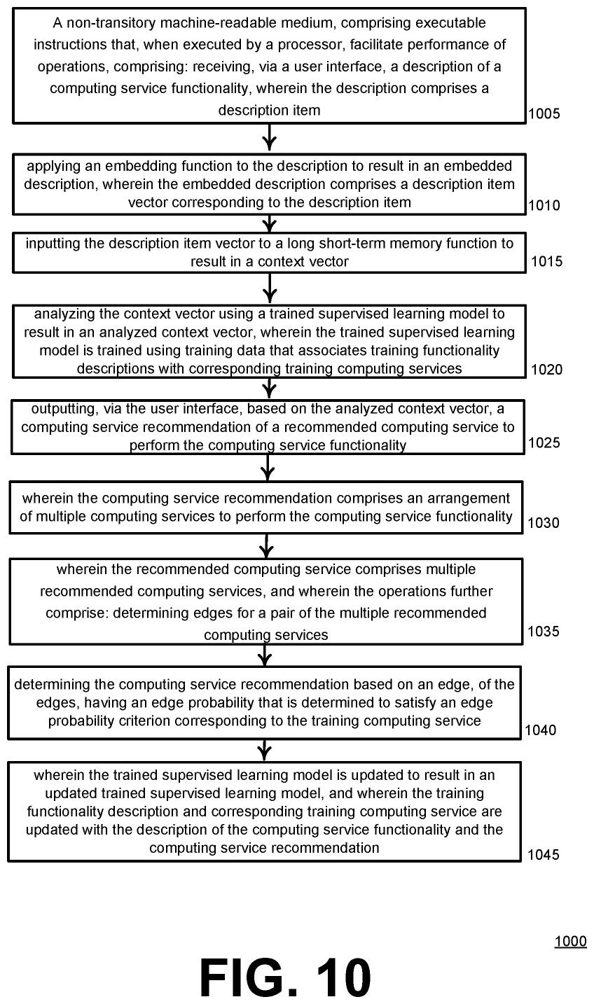

Turning now to FIG. 10, the figure illustrates a non-transitory machine-readable medium 1000 comprising at block 1005 executable instructions that, when executed by a processor, facilitate performance of operations, comprising: receiving, via a user interface, a description of a computing service functionality, wherein the description comprises a description item; at block 1010 applying an embedding function to the description to result in an embedded description, wherein the embedded description comprises a description item vector corresponding to the description item; at block 1015 inputting the description item vector to a long short-term memory function to result in a context vector; at block 1020 analyzing the context vector using a trained supervised learning model to result in an analyzed context vector, wherein the trained supervised learning model is trained using training data that associates training functionality descriptions with corresponding training computing services; at block 1025 outputting, via the user interface, based on the analyzed context vector, a computing service recommendation of a recommended computing service to perform the computing service functionality; at block 1030 wherein the computing service recommendation comprises an arrangement of multiple computing services to perform the computing service functionality; at block 1035 wherein the recommended computing service comprises multiple recommended computing services, and wherein the operations further comprise: determining edges for a pair of the multiple recommended computing services; at block 1040 determining the computing service recommendation based on an edge, of the edges, having an edge probability that is determined to satisfy an edge probability criterion corresponding to the training computing service; and at block 1045 wherein the trained supervised learning model is updated to result in an updated trained supervised learning model, and wherein the training functionality description and corresponding training computing service are updated with the description of the computing service functionality and the computing service recommendation.

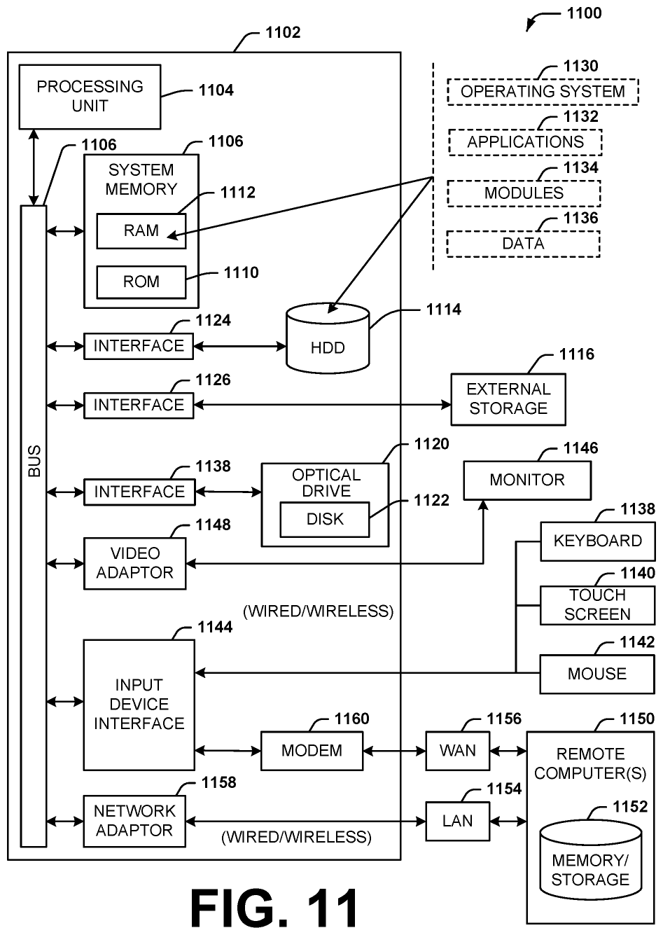

In order to provide additional context for various embodiments described herein, FIG. 11 and the following discussion are intended to provide a brief, general description of a suitable computing environment 1100 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors and may include a cache memory. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

Computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can comprise a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a system comprising a processor via a user interface, a description of at least one computing service functionality, wherein the description comprises at least one description item;
applying, by the system, an embedding function to the description to result in an embedded description, wherein the embedded description comprises at least one description item vector corresponding to the at least one description item;
inputting, by the system, the at least one description item vector to a recurrent neural network function to result in a context vector;
analyzing, by the system, the context vector using a trained supervised learning model to result in an analyzed context vector, wherein the trained supervised learning model is trained using a training corpus that associates at least one training functionality description with a corresponding at least one training computing service; and
outputting, via the user interface, based on the analyzed context vector, a computing service recommendation of at least one recommended computing service to perform the at least one computing service functionality.

2. The method of claim 1, wherein the at least one description item comprises at least one of: at least one word, at least one image signal representing at least one portion of at least one image, or at least one audio signal representing at least one portion of at least one sound.

3. The method of claim 1, wherein the computing service recommendation comprises an arrangement of recommended computing services to perform the at least one computing service functionality.

4. The method of claim 1, wherein the context vector comprises at least one of: a usage frequency of the at least one description item or an order of the at least one description item.

5. The method of claim 1, wherein the analyzed context vector comprises at least one computing service probability corresponding to at least one computing service to perform the at least one computing service functionality, and the method further comprising determining, by the system, the computing service recommendation based on the at least one computing service probability being determined to satisfy at least one functionality probability criterion corresponding to the at least one training computing service.

6. The method of claim 5, further comprising:
determining, by the system, edges for at least one pair of the at least one recommended computing service; and
determining, by the system, the computing service recommendation based on at least one edge, of the edges, having an edge probability that is determined to satisfy an edge probability criterion corresponding to the at least one training computing service.

7. The method of claim 1, further comprising:
determining, by the system, edges for at least one pair of the at least one recommended computing service; and
determining, by the system, the computing service recommendation based on at least one edge, of the edges, having an edge probability that is determined to satisfy an edge probability criterion corresponding to the at least one training computing service.

8. The method of claim 1, wherein the trained supervised learning model is updated to result in an updated trained supervised learning model, and wherein the training functionality description and corresponding at least one training computing service are updated with the description of the at least one computing service functionality and the computing service recommendation.

9. A system, comprising:
a device comprising a processor configured to:
receive a description from a user interface of at least one computing service functionality, wherein the description comprises at least one description item;
apply an embedding function to the description to result in an embedded description, wherein the embedded description comprises at least one description item vector corresponding to the at least one description item;
input the at least one description item vector to a long short-term memory function to result in a context vector;
analyze the context vector with a trained supervised learning model to result in an analyzed context vector, wherein the trained supervised learning model is trained with a training corpus that associates at least one training functionality description with a corresponding at least one training computing service; and
output, to the user interface, based on the analyzed context vector, a computing service recommendation of at least one recommended computing service to perform the at least one computing service functionality.

10. The system of claim 9, wherein the computing service recommendation comprises an arrangement of recommended computing services to perform the at least one computing service functionality.

11. The system of claim 9, wherein the analyzed context vector comprises at least one computing service probability corresponding to at least one computing service to perform the at least one computing service functionality, the processor further configured to determine the computing service recommendation based on the at least one computing service probability meeting at least one functionality probability criterion corresponding to the at least one training computing service.

12. The system of claim 11, wherein the processor is further configured to:
determine edges for at least one pair of the at least one recommended computing service; and
determine the computing service recommendation based on at least one edge, of the edges, having an edge probability that meets at least one edge probability criterion corresponding to the at least one training computing service.

13. The system of claim 9, wherein the processor is further configured to:
determine edges for at least one pair of the at least one recommended computing service; and
determine the computing service recommendation based on at least one edge, of the determined edges, having an edge probability that meets at least one edge probability criterion corresponding to the at least one training computing service.

14. The system of claim 9, wherein the trained supervised learning model is updated to result in an updated trained supervised learning model, and wherein the training functionality description and corresponding at least one training computing service are updated with the description of the at least one computing service functionality and the computing service recommendation.

15. A non-transitory machine-readable medium, comprising executable instructions that, when executed by a processor, facilitate performance of operations, comprising:
receiving, via a user interface, a description of a computing service functionality, wherein the description comprises a description item;
applying an embedding function to the description to result in an embedded description, wherein the embedded description comprises a description item vector corresponding to the description item;
inputting the description item vector to a long short-term memory function to result in a context vector;
analyzing the context vector using a trained supervised learning model to result in an analyzed context vector, wherein the trained supervised learning model is trained using training data that associates training functionality descriptions with corresponding training computing services; and
outputting, via the user interface, based on the analyzed context vector, a computing service recommendation of a recommended computing service to perform the computing service functionality.

16. The non-transitory machine-readable medium of claim 15, wherein the computing service recommendation comprises an arrangement of multiple computing services to perform the computing service functionality.

17. The non-transitory machine-readable medium of claim 15, wherein the analyzed context vector comprises a computing service probability corresponding to a computing service to perform the computing service functionality, and wherein the operations further comprise determining the computing service recommendation based on the computing service probability being determined to satisfy a functionality probability criterion corresponding to the training computing service.

18. The non-transitory machine-readable medium of claim 17, wherein the recommended computing service comprises multiple recommended computing services, and wherein the operations further comprise:
determining edges for a pair of the multiple recommended computing services; and
determining the computing service recommendation based on an edge, of the edges, having an edge probability that is determined to satisfy an edge probability criterion corresponding to the training computing service.

19. The non-transitory machine-readable medium of claim 15, wherein the recommended computing service comprises multiple recommended computing services, and wherein the operations further comprise:
determining edges for a pair of the multiple recommended computing services; and
determining the computing service recommendation based on an edge, of the edges, having an edge probability that is determined to satisfy an edge probability criterion corresponding to the training computing service.

20. The non-transitory machine-readable medium of claim 15, wherein the trained supervised learning model is updated to result in an updated trained supervised learning model, and wherein the training functionality description and corresponding training computing service are updated with the description of the computing service functionality and the computing service recommendation.
